(19) United States
(12) Patent Application Publication
(10) Pub. No.: US 2003/0161927 A1
(43) Pub. Date: Aug. 28, 2003

(54) Pet food

(76) Inventors: Geoffrey C Bryant, Thame (GB); Philip Roger Blanshard, Harrowgate (GB); Stewart Townsend, Yorba Linda, CA (US)

Correspondence Address: FULBRIGHT & JAWORSKI, LLP, 1301 MCKINNEY, SUITE 5100, HOUSTON, TX, 77010-3095, US

(21) Appl. No.: 10/258,085

(22) PCT Filed: Apr. 6, 2001
(86) PCT No.: PCT/GB01/01592

(30) Foreign Application Priority Data
Apr. 7, 2000 (GB) 0008657.9

(51) Int. Cl. A21D 10/00

(52) U.S. Cl. 426/549

(57) ABSTRACT

A hard pet biscuit-like product is made by heating briefly a mixture comprising pre-gelatinised starch, water and a plasticiser at a pressure of at least 5 MPa. The product is very hard and can contain volatile and heat labile components.

### TECHNICAL FIELD

The present invention relates to a pet food, particularly a dry pet biscuit.

### BACKGROUND OF THE INVENTION

Animal, particularly dog, food is often in the form of dry biscuits. One type of such food is provided as a “treat” for an animal, to be eaten between main meals. Such products are desirably hard so that they last a long time in the animal's mouth, retain the animal's interest and provide an effective tooth cleaning action.

Known animal biscuits are made by cooking a low water content dough at a high temperature. Typically, the dough includes flour, fat and salt and about 20 to 30% water and is dried in an oven for between 5 and 40 minutes at above 100° C. and often above 150° C.; faster drying can lead to burning of the product; the risk of burning also limits how much water can be removed from the biscuit. Shorter drying times will result in removal of less water.

It would be desirable to make a hard biscuit in a shorter time than is possible with conventional techniques.

### BRIEF SUMMARY OF THE INVENTION

A hard pet biscuit-like product is made by heating briefly a mixture comprising pre-gelatinised starch, water and a plasticiser at a pressure of at least 5 MPa. The product is very hard and can contain volatile and heat labile components.

### DETAILED DESCRIPTION OF THE INVENTION

According to the invention there is provided a method for making a foodstuff comprising forming a mixture comprising pre-gelatinised starch, water and plasticiser; and heating the mixture while subjecting it to a pressure of at least 5 MPa.

Preferably, the mixture is subjected to a pressure of at least about 10 MPa.

Preferably, the mixture is introduced into a mould in which it is subjected to the pressure. Preferably, the mould surface is heated to a temperature of from about 90° C. to about 170° C., more preferably from about 100° C. to about 130° C., most preferably about 120° C.

Preferably, the mixture is subjected to the high pressure for at least about 10 s, more preferably at least about 15 s, most preferably from about 20 s to about 40 s. Also preferably, the mixture is subjected to the high pressure for no more than about 60 s.

The preferred starch source is breadcrumbs.

Preferred plasticisers include glycol (the most preferred plasticiser) and glycerol. Preferably, the plasticiser is present at up to about 6%, more preferably at from about 1% to about 6%, most preferably at about 1.5% to 4%, by weight of mixture.

Preferably the water content of the mixture is no more than about 15%, more preferably no more than about 10%, more preferably from about 2% to 10%, still more preferably about 6%, by weight of mixture.

In addition to the main ingredients of starch, water and plasticiser, additives may be present, including edible fibre such as bran, preferably broad bran which has a particle size of from about 1 mm to about 4 mm. If it is employed, the fibre content is preferably from about 5% to 20%, more preferably from about 8% to 10%, by weight of mixture. The presence of fibre imparts a laminar material structure to the biscuit.

Other preferred additives include flavourants, colourants, preservatives, antioxidants and functional dietary additives such as minerals and vitamins. Since the biscuits made according to the invention are subjected to only low temperatures during cooking, thermally unstable and volatile additives can be used which could not be used in conventional, higher temperature, biscuit making processes. The Arrhenius equation predicts that reactions having an activation energy of 50 kJ/mol proceed more than 10 times more quickly at 180° C. than at 110° C.; reactions having an activation energy of 200 kJ/mol proceed more than 15000 times more quickly at 180° C. than at 110° C. Most reactions have an activation energy within the range 50 kJ/mol to 200 kJ/mol, and it will be appreciated that less additive is lost by reaction in processes according to the invention than in conventional baking processes, and that some additives effectively unusable in conventional baking processes are usable in processes according to the invention. It will also be appreciated that the lower temperatures, lower cooking times and higher pressures of processes according to the invention (compared to conventional baking processes) raises the maximum acceptable boiling point of usable additives.

An example of a volatile additive is eucalyptus oil. In conventional processes, about 80% of the eucalyptus oil in the dough is lost during cooking; in preferred processes according to the invention, no more than 10% is lost.

The starch content of the mixture is preferably at least about 40%, preferably about 70% to about 98%, by weight. A mixture containing approximately equal quantities of starch in the form of breadcrumbs and caseinate has been found to provide a satisfactory product.

It is also preferred that the mixture includes about 1% by weight of a flow improving additive such a silica to improve the flow of the mixture into the moulds.

The invention also provides a dry biscuit-like product comprising heat labile and/or volatile components.

The invention also provides a dry biscuit-like product manufactured by a method of the invention in which the heat labile and/or volatile components are such as could not be used in conventional dry biscuit manufacturing processes because of their lability or volatility.

The invention also provides a dry biscuit-like product manufactured by a method of the invention exhibiting longer lasting times when chewed by dogs than dry biscuits manufactured by conventional dry biscuit manufacturing processes.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

The invention will be further described by the following example.

| A mixture comprising: | | |
|---|---|---|
| breadcrumbs with a water | 95.25% | by weight |
| content of 3 to 7% | | |
| beef liver powder | 2% | by weight |
| glycol | 2% | by weight |
| smoke aroma | 0.5% | by weight |
| red iron oxide | 0.25% | |

was made in a ribbon blend mixer. 25 g of the mixture was introduced into each mould of two arrays each of 32 titanium coated steel moulds. The bottom half of each mould was an annular cavity and the top half a complementary annulus. The moulds were of dimensions to produce lenticular toroidal biscuits of 55 mm diameter with a central hole of 18 mm diameter, a maximum thickness of 12 mm and a minimum thickness at the outside edge of 8 mm.

Each mould was subjected to a pressure of about 4 tonnes for about 15 to 40 s. While being held at that pressure the top mould was heated to about 110° C. to 120° C. and the bottom mould to about 120° C. to 130° C.

The press used to apply pressure to the moulds was a hydraulic press, a JRD/Bipel 170T upstroking press.

The toroidal biscuits produced were found to have a relatively high density compared with similar biscuits produced by conventional techniques, no internal voids and a water content of about 6% by weight. They were very hard and exhibited long lasting times when chewed by dogs.

What is claimed is:

1. A method for making a foodstuff comprising:
forming a mixture comprising pre-gelatinised starch, water and a plasticiser; and heating the mixture while subjecting it to a pressure of at least 5 MPa.

2. A method according to claim 1 in which the mixture contains no more than 15%, preferably no more than 10%, by weight water.

3. A method according to claim 1 or 2 in which the pre-gelatinised starch is breadcrumbs.

4. A method according to any preceding claim in which the mixture is introduced into a mould in which it is heated and pressurised.

5. A method according to any preceding claim in which the mixture is subjected to the high pressure for at least about 10 s, more preferably at least about 15 s, most preferably from about 20 s to about 40 s.

6. A method according to any preceding claim in which the mixture is subjected to the high pressure for no more than about 60 s.

7. A method according to any preceding claim in which the plasticiser is present at up to about 6%, more preferably at from about 1% to about 4%, most preferably at about 1.5%, by weight of mixture.

8. A dry biscuit-like product comprising heat labile and/or volatile components.

9. A dry biscuit-like product according to claim 8 manufactured by a method according to any of claims 1 to 7 in which the heat labile and/or volatile components are such as could not be used in conventional dry biscuit manufacturing processes because of their lability or volatility.

10. A dry biscuit-like product manufactured by a method according to any of claims 1 to 7 exhibiting longer lasting times when chewed by dogs than dry biscuits manufactured by conventional dry biscuit manufacturing processes.
